(19) United States
(12) Patent Application Publication
(10) Pub. No.: US 2002/0044896 A1
(43) Pub. Date: Apr. 18, 2002

(54) Catalytic converter configuration with catayst carrier bodies and device and method for the manufacture thereof

(76) Inventors: Wolfgang Maus, Bergisch Gladbach (DE); Rolf Bruck, Bergisch Gladbach (DE)

Correspondence Address: LERNER AND GREENBERG, P.A., POST OFFICE BOX 2480, HOLLYWOOD, FL, 33022-2480, US

(21) Appl. No.: 09/946,760

(22) Filed: Sep. 4, 2001

Related U.S. Application Data
(63) Continuation of application No. PCT/EP00/01488, filed on Feb. 23, 2000.

(30) Foreign Application Priority Data
Mar. 1, 1999 (DE) 199 08 834.9

(51) Int. Cl. B01D 53/34; F01N 3/00; B01J 35/02

(52) U.S. Cl. 422/168; 422/171; 422/169; 422/170; 422/177; 422/211; 502/527.17

(57) ABSTRACT

A catalytic converter configuration for exhaust gas systems of motor vehicles includes a housing surrounding at least two substantially successively disposed catalyst carrier bodies each having axial channels with normal cross-sectional areas. The first catalyst carrier body has at least two or more through-flow apertures running parallel to the axial channels and having second cross-sectional areas substantially larger than the first cross-sectional areas. A device and a method are provided for manufacturing a catalyst carrier body, in particular the first catalyst carrier body, from at least one stack of a multiplicity of at least partly structured sheet metal layers forming a multiplicity of channels through which a fluid can flow. A fork-like twisting device is rotatable about a central axis, engages each stack and is substantially surrounded by a mold. Active winding spindles are disposed on a carrier of the twisting device. The spindles can be brought into engagement with the at least one stack and are movable for expanding the twisted stack, in particular for forming through-flow apertures within the catalyst carrier body.

### CROSS-REFERENCE TO RELATED APPLICATION

This application is a continuation of copending International Application No. PCT/EP00/01488, filed Feb. 23, 2000, which designated the United States.

### BACKGROUND OF THE INVENTION

### Field of the Invention

The invention relates to a catalytic converter configuration for exhaust gas systems of motor vehicles, with at least two catalyst carrier bodies. The invention also relates to a device and a method for manufacturing a catalyst carrier body, in particular for use in the catalytic converter configuration.

It is known to apply at least one catalytically active substance to a catalyst carrier body in order to provide for the catalytic conversion of components of an exhaust gas of an internal combustion engine. Catalyst carrier bodies are manufactured, for example, from layers of structured metal sheets. The metal sheets are layered and/or twisted on top of one another and thereby form a metallic honeycomb body with axial gas channels through which an exhaust gas is flowable. The catalyst carrier body is disposed in a housing which is part of an exhaust gas system.

In particular with so-called starter catalytic converters, that is catalytic converters which are installed close to the engine, and therefore reach operating temperature very rapidly after the engine starts, it is known to use catalyst carrier bodies having spirally wound, alternating layers of flat and corrugated metal sheets. In order to keep the pressure loss of that catalyst carrier body low, it is provided in part that the central area is kept as free as possible from windings so that some of the exhaust gases can flow through there unobstructed. That is acceptable since starter catalytic converters are generally operated together with other pollutant-reducing measures, that is to say other catalyst carrier bodies disposed further along.

In the context of starter catalytic converters, because of the installation close to the engine, and the space problem occurring there, there is the difficulty of placing catalytic converter configurations in a manner which is space saving and advantageous in terms of flow technology. It must furthermore be considered that catalyst carrier bodies in such catalytic converter configurations can be damaged by the exhaust gas flowing directly onto their front side, in particular with the high temperatures of the exhaust gas flows occurring over a long period of operation when installed close to the engine, which can lead to a decreasing rate of conversion.

German Published, Non-Prosecuted Patent Application DE 197 55 703 A1, corresponding to U.S. patent application Ser. No. 09/518,469, filed Mar. 3, 2000, discloses a catalyst carrier body configuration which is known for installation close to the engine. Installation between a cylinder head and a manifold of an internal combustion engine is made possible by placing a collar on the housing surrounding the catalyst carrier body. However, a configuration having a further catalyst carrier body disposed directly behind it for exhaust gas cleansing of the exhaust gases during long-term operation is not provided, taking the selected installation position into account, and is also not possible.

A catalyst carrier body is known from German Utility Model DE-GM 86 31 017.8, corresponding to U.S. Pat. No. 4,842,954, in particular for use in a catalytic converter configuration as a starter catalytic converter, which has a central area free of windings and alternating layers of flat and corrugated metal sheets spirally wound for the manufacture thereof. The innermost layer which surrounds the winding-free central area is composed of a corrugated metal sheet, for technical manufacturing reasons. Although such a catalyst carrier body is, in principle, suitable as a starter catalytic converter for placement together with a further catalyst carrier body, because of the central aperture, when installation is close to the engine, the problem of possible damage to a following catalyst carrier body arises because of the direct and central flow onto the following catalyst carrier body through the winding-free central area. Due to the use of the central configuration of the winding-free area, it is precisely the portion of the exhaust gas that is guided directly onto the front of a possible following catalyst carrier body which has the greatest speed and the highest temperature because of the flow profile in the configuration. As described above, that can lead to particularly rapid damage to a possible following catalyst carrier body in prolonged operation, that is to say at high exhaust gas temperature.

Devices and methods are known which are suitable for manufacturing a catalyst carrier body of twisted metal sheets. International Publication WO97/00725, corresponding to U.S. Pat. Nos. 6,029,488 and 6,115,906, describes, for example, such a device for manufacturing a catalyst carrier body from at least one stack of a multiplicity of at least partly structured sheet metal layers, which form a multiplicity of channels that can be flowed through by a fluid. The device has a fork-like twisting device which is rotatable about a central axis, engages with each stack, and includes a mold that surrounds the twisting device and the internal contour of which corresponds to the external contour of the catalyst carrier body to be manufactured. The twisting device also has at least two winding spindles which can be brought into engagement with the stack or stacks. The stack is twisted into a honeycomb body which fills the mold, by relative rotation of the twisting device with respect to the mold. The configuration of at least one winding-free area, which would be necessary because of the flow technology requirements described above, were a catalyst carrier body manufactured in that way to be installed in a catalytic converter configuration as a starter catalytic converter, is not provided for with the device according to the teaching of International Publication WO 97/00725, corresponding to U.S. Pat. Nos. 6,029,488 and 6,115,906, nor with the method according to the teaching therein.

### SUMMARY OF THE INVENTION

It is accordingly an object of the invention to provide a catalytic converter configuration for exhaust gas systems of motor vehicles with catalyst carrier bodies, which requires a small amount of space and, when installed close to the engine, permits advantageous operation in flow technology terms, with the greatest possible useful life for the catalyst carrier body being used, as well as a device and a method for the simple and cost effective manufacture of corresponding catalyst carrier bodies, which overcome the hereinafore-mentioned disadvantages of the heretofore-known devices and methods of this general type.

With the foregoing and other objects in view there is provided, in accordance with the invention, a catalytic converter configuration for exhaust gas systems of motor vehicles, comprising a housing and at least first and second substantially successively disposed catalyst carrier bodies defining an exhaust gas flow profile. The catalyst carrier bodies each have axially extending channels with substantially pre-determined first normal cross-sectional areas. The first catalyst carrier body has a central flow-receiving region. The first catalyst carrier body also has at least two or more through-flow apertures disposed decentrally to the exhaust gas flow profile. The through-flow apertures extend parallel to the axial channels and have second cross-sectional areas substantially larger than the first cross-sectional areas. At least some of the axial channels are disposed between the through-flow apertures in the central flow-receiving region. The catalyst carrier bodies are disposed in the housing.

The catalyst carrier bodies themselves are preferably composed of metal and are coated with a catalytically active material. It is, however, also possible to manufacture them directly from catalytically active material. The shape of the housing and the catalyst carrier body received therein can be adapted to a large degree to the space at the point of installation.

The embodiment of the catalytic converter configuration according to the invention, with at least two catalyst carrier bodies which are disposed substantially following one another, above all offers the advantage that such a configuration has a small space requirement, wherein good flow behavior is provided at the same time. Furthermore, the at least two or more through-flow apertures of the first catalyst carrier body of the catalytic converter configuration, provided according to the invention, make it possible for some of the exhaust gases to be able to flow through there unobstructed. This is advantageous in particular when the first catalyst carrier body is configured as a starter catalytic converter. In addition, a relatively large central area, free from windings, does not have to remain clear in the first catalyst carrier body, which is configured as a starter catalytic converter. According to the invention, this results in homogenized flow behavior in the area of the front of the second catalyst carrier body directly receiving the flow, and thus reduces the damaging effect of the direct exhaust gas flow upon the second catalyst carrier body. Through the use of this measure, it is firstly possible to place the second catalyst carrier body in a space-saving manner substantially following the first catalyst carrier body, which in particular is configured as a starter catalytic converter. This is due to the fact that, through the use of the alteration of the flow behavior described, because of the at least two through-flow apertures in the first catalyst carrier body, the flowing of hot exhaust gases onto the second catalyst carrier body during prolonged operation has a less negative effect on the front of the second catalyst carrier body directly receiving the flow, than is the case when there is a direct flow through a large, central through-flow aperture.

In accordance with another feature of the invention, it is particularly advantageous in terms of flow technology if the second cross-sectional areas of the through-flow apertures of the first catalyst carrier body are 5 to 20 times, preferably by 10 to 15 times, larger than the first cross-sectional areas of the channels running axially through the respective catalyst carrier body or bodies. In this way a particularly good through-flow is ensured through the through-flow apertures, in particular in prolonged operation.

In accordance with a further feature of the invention, the through-flow apertures of the first catalyst carrier body have longitudinal axes running respectively through the geometrical center point of their cross-sectional areas, and those axes do not coincide with the longitudinal axis running though the geometrical center point of the first catalyst carrier body.

This particularly preferred, off-center configuration, of the through-flow apertures means that the speed at which the exhaust gases pass through the through-flow apertures is less than with a single, central through-flow aperture, as is the case in the prior art. The reason for this lies in the parabolic speed profile which is produced in pipes when there is a steady flow, depending upon the radius. The underlying model is also approximately applicable for the flow in a substantially tubular catalytic converter configuration. The flow speed of the hot exhaust gas flowing directly through the through-flow apertures, which speed is reduced according to the invention by the configuration of the through-flow apertures, reduces the risk of damage to the second catalyst carrier body disposed downstream of the first catalyst carrier body.

In accordance with an added feature of the invention, at least the first catalyst carrier body is installed close to the engine, and it is preferred in particular to place the first catalyst carrier body in an end region of a manifold of an internal combustion engine. The first catalyst carrier body can consequently satisfy its task as a starter catalytic converter particularly well, especially in the cold starting phase of the motor vehicle.

In accordance with an additional feature of the invention, in order to keep the dimensions of the catalytic converter configuration according to the invention as small as possible, the catalyst carrier bodies are disposed so as to directly follow one another. The distance at which they are spaced apart depends on the spatial conditions, and is preferably within a range of 0.5 cm to 10 cm. A distance apart of 2 cm to 5 cm is particularly preferred.

In accordance with yet another feature of the invention, the housing for the at least two catalyst carrier bodies is divided into a plurality of housing sections, the housing sections are connected to one another through the use of tubular connecting pieces and each catalyst carrier body is received in a respective housing section. The connection of the housing sections to each other and their respective connection to the tubular connecting pieces can be accomplished in many different ways, for example by screwing, brazing, as well as in a releasable manner by connection through the use of flange-type sections on the respective sections and connecting pieces, which can be screwed, clamped, and so forth. The configuration of the housing as a whole in the exhaust gas system of motor vehicles can also be provided in the described manner. The cross-sections of the individual housing sections, and the connecting, tubular connecting pieces, can be adapted to the respective spatial conditions.

However, all of the housing sections and/or connecting pieces preferably have a uniform cross-section. However, the second catalyst carrier body can also have a larger cross-section than the first.

In accordance with yet a further feature of the invention, the housing is constructed with only one housing section which receives the catalyst carrier body. The housing can be configured in a particularly compact manner in this way.

In accordance with yet an added feature of the invention, in order to improve stability, as well as to provide good flow behavior even with mechanical stresses possibly having an effect, as can occur, for example, during the installation of the catalyst carrier body, the through-flow apertures of the first catalyst carrier body are preferably provided with an edge which is thickened, and in particular is composed of a plurality of metal sheets lying one on top of another.

In accordance with yet an additional feature of the invention, at least the first catalyst carrier body is a honeycomb body formed substantially from metal sheets twisted in an S-shape or involute shape, with channels running axially.

With objects of the invention in view, there is also provided a device for manufacturing a catalyst carrier body, in particular a first catalyst carrier body of the catalytic converter configuration, comprising a mold having an inner contour corresponding to an outer contour of a catalyst carrier body to be manufactured, and a fork-like twisting device substantially surrounded by the mold and rotatable about a central axis for engaging at least one stack of a multiplicity of at least partly structured sheet metal layers for forming the catalyst carrier body with a multiplicity of channels through which a fluid can flow. The twisting device has active winding spindles disposed on a carrier of the twisting device to be brought into engagement with the at least one stack and moved for expanding the at least one stack after twisting, in particular for forming through-flow apertures within the catalyst carrier body.

Through the use of the movable winding spindles of the twisting device, it is possible in a particularly easy and consequently cost-effective manner to manufacture catalyst carrier bodies, in particular first catalyst carrier bodies of the catalytic converter configuration described above, which are preferably substantially formed from metal sheets twisted in an S-shape or involute shape, and to provide them with the through-flow apertures described hereinabove.

In accordance with another feature of the invention, the active winding spindles are respectively sequentially provided in the axial direction with a first area having as small a cross-section as possible and a second area with a larger cross-section and a conical transitional area. The axial extent of the first and the second area respectively corresponds to at least the axial extent of the catalyst carrier body to be manufactured. The cross-section of the second area substantially corresponds to the desired cross-section of the respective through-flow aperture.

In accordance with a further feature of the invention, the active winding spindles are movable in an axial direction with respect to the stacks from which a catalyst carrier body is formed by twisting. This movement can also be uniform for all of the active winding spindles, or can be individual for each individual active winding spindle. The twisting movement relative to the mold relates to all of the active winding spindles.

The active winding spindles are preferably configured in such a way that, by a simple movement in the axial direction, the stacks can be brought into engagement, and the twisted stacks can be expanded in the axial direction. Therefore, relatively simple mechanical construction of the active winding spindles is possible. Thus, particularly cost-effective manufacture of the device according to the invention, and thereby also eventually of a catalyst carrier body is possible.

Additionally, the expansion takes place in the conical transitional area between the first area and the second area of the respective active winding spindle, whereby the respective through-flow aperture is produced in a very uniform manner in the catalyst carrier body, particularly since the desired cross-section of the respective through-flow aperture is substantially pre-determined by the cross-section of the second area of the respective active winding spindle.

In accordance with an added feature of the invention, the first preferred configuration of the device for manufacturing a catalyst carrier body is provided with a base plate which supports the stack to be twisted against the axial force applied by the active winding spindles. In this way, apertures are provided in the area of the respective active winding spindles. The active winding spindles pass through the apertures when expanding the twisted stack.

In accordance with an additional feature of the invention, in a second preferred configuration, the active winding spindles are moveable perpendicular to their respective longitudinal axes, while keeping their axial orientation relative to the stack. It is particularly preferable if the active winding spindles are movable at an amplitude which corresponds to the desired diameter of the respective through-flow aperture. In this second preferred configuration, the active winding spindles also serve both to engage with the respective stack or stacks to be twisted, as well as for expansion for forming the respective through-flow apertures in the catalyst carrier body formed by twisting.

The movement of the active winding spindles according to the second preferred configuration of the device for manufacturing a catalyst carrier body can be performed substantially through the use of a circular movement of one of the active winding spindles. The radius of the circular movement increases until reaching the amplitude which corresponds to the respective desired diameter of the cross-section of the respective through-flow aperture.

In accordance with yet another feature of the invention, the active winding spindles of the second preferred configuration of the device are configured to be individually movable. However, it is also possible to configure the active winding spindles to move together. For instance, the entire twisting device may be correspondingly movably configured.

The second preferred configuration of the device for manufacturing a catalyst carrier body offers the advantage of a small structural height.

In accordance with yet a further feature of the invention, both preferred configurations of the device are constructed in such a way that the mold and the twisting device are rotatable with respect to one another. Furthermore, the mold can be configured with a plurality of parts, and be foldable through the use of suitable mechanisms.

With the objects of the invention in view, there is additionally provided a method for manufacturing a catalyst carrier body, in particular a first catalyst carrier body of the catalytic converter configuration, which comprises layering at least one stack of a multiplicity of at least partly structured sheet metal layers. Each stack is inserted into a mold substantially corresponding to an outer shape of the catalyst carrier body to be manufactured. Each stack is held with a twisting device disposed in a central area of the mold. All of the stacks are twisted into a catalyst carrier body entirely filling the mold, by exerting a relative rotation between the twisting device and the mold. Active winding spindles of the twisting device are moved to expand the twisted stacks, so that in particular through-flow apertures are introduced into the catalyst carrier body. The movement of the active winding spindles was described hereinabove.

Complicated courses of movement are eliminated through the use of the method described herein. The method is simple and can be carried out without further difficulties.

In accordance with another mode of the invention, each stack is folded about a respective bending line, and preferably one active winding spindle is respectively present in the area of each bending line.

In accordance with a concomitant mode of the invention, the at least one stack is inserted into an open mold with at least two mold segments, and the mold is closed by pivoting the mold segments counter to the direction of rotation of the twisting device, when a pre-determined degree of twisting is reached. It is not compulsory for the stack to be completely twisted around itself. The closing procedure of the mold can be initiated when the extent of the section of the stack that is not yet twisted is smaller than or the same as the length of the periphery of the mold segment. If the closing procedure is then initiated, each segment aids the twisting procedure, as the segments closing together press the sections which are not yet twisted towards the axis.

Other features which are considered as characteristic for the invention are set forth in the appended claims.

Although the invention is illustrated and described herein as embodied in a catalytic converter configuration with catalyst carrier bodies and a device and a method for the manufacture thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, partly sectional, side-elevational view of a preferred configuration of a catalytic converter configuration according to the invention;

FIG. 2 is a plan view of a first catalyst carrier body of a preferred configuration of the catalytic converter configuration according to the invention;

FIG. 3 is a fragmentary, partly sectional, side-elevational view of a first preferred configuration of a device according to the invention for manufacturing a catalyst carrier body; and

FIG. 4 is a view similar to FIG. 3 of a second preferred configuration of a device according to the invention for manufacturing a catalyst carrier body.

### DESCRIPTION OF THE PREFERRED EMBODIMENTS

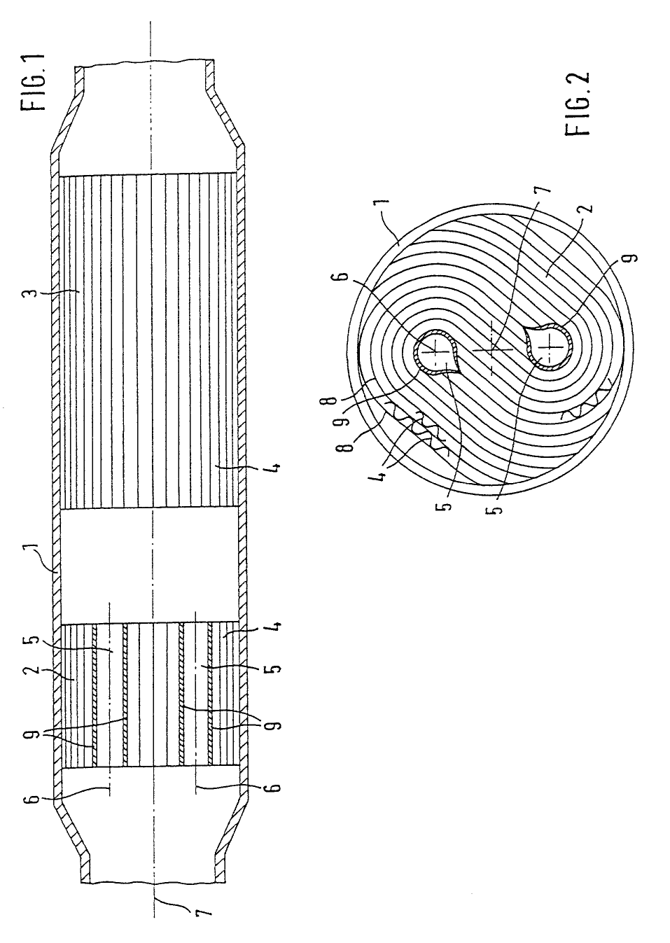

Referring now to the figures of the drawings in detail and first, particularly, to FIG. 1 thereof, there is seen a fragmentary, partly sectional, side view of a preferred embodiment of a catalytic converter configuration according to the invention. First and second catalyst carrier bodies 2, 3 are disposed in a common housing 1. Both the first catalyst carrier body 2 and the second catalyst carrier body 3 have channels 4 running axially and form a honeycomb body. The catalyst carrier bodies 2, 3 are coated with non-illustrated catalytically active material. The first catalyst carrier body 2 is installed as a starter catalytic converter to be placed close to the engine. It is provided with two through-flow apertures 5 parallel to the axial channels 4. These apertures each have a cross-sectional area approximately 16 times that of the axial channels. The through-flow apertures 5 of the first catalyst carrier body 2 each have an edge 9 which is thickened, and is composed of a plurality of metal sheets structured in the same way, lying one on top of another. The through-flow apertures 5 each have axial longitudinal axes 6 running through a geometrical center point of their cross-sectional areas, which do not coincide with a longitudinal axis 7 running through a geometrical center point of the first catalyst carrier body. Thus, the through-flow apertures or channels 5 are disposed decentrally to an exhaust gas flow profile. This longitudinal axis 7 is also, at the same time, a longitudinal axis running through a geometrical center point of the second catalyst carrier body 3. End sections of the housing 1 have a smaller diameter than the housing 1 per se for matching a pipe diameter of a remaining exhaust gas system.

The configuration of the catalyst carrier bodies 2, 3 is such that their respective diameters substantially correspond with the internal diameter of the tubular housing 1, and they are consequently fitted into the housing. A distance through which the first catalyst carrier body 2 and the second catalyst carrier body 3 are spaced apart is a few centimeters. Through the use of the off-center configuration of the through-flow apertures 5 in the first catalyst carrier body, the speed of the exhaust gases passing through the respective through-flow apertures 5 is reduced as compared to exhaust gases which pass through a central aperture. Consequently, the risk of damage in the area of the front of the second catalyst carrier body, directly receiving the flow, is also reduced. The honeycomb bodies described above are preferably manufactured at least in part from structured metal sheets, which are joined to one another and to the housing by brazing.

FIG. 2 shows a cross-section through the first catalyst carrier body 2 of the preferred embodiment of the catalytic converter configuration of FIG. 1.

The first catalyst carrier body 2 is disposed in the housing 1. The housing 1 is configured substantially tubularly. The catalyst carrier body 2 is provided with a multiplicity of metal sheets twisted substantially in an S-shape, which form a honeycomb body with the channels 4 running axially. The through-flow apertures 5 of the first catalyst carrier body 2 each have an edge 9 which is thickened, and in particular is composed of a plurality of metal sheets 8 lying on one another. The longitudinal axes 6 running through the geometrical center point of the respective cross-sectional areas of the through-flow apertures do not coincide with the longitudinal axis 7 running through the geometrical center point of the first catalyst carrier body 2. Other configurations of the catalyst carrier body 2 are possible. In particular, the catalyst carrier body 2 can also be formed from metal sheets twisted in an involute manner, and several through-flow apertures 5 can be provided. It may be seen that at least some of the axial channels 4 are disposed between the through-flow apertures or channels 5 in a central flow-receiving region.

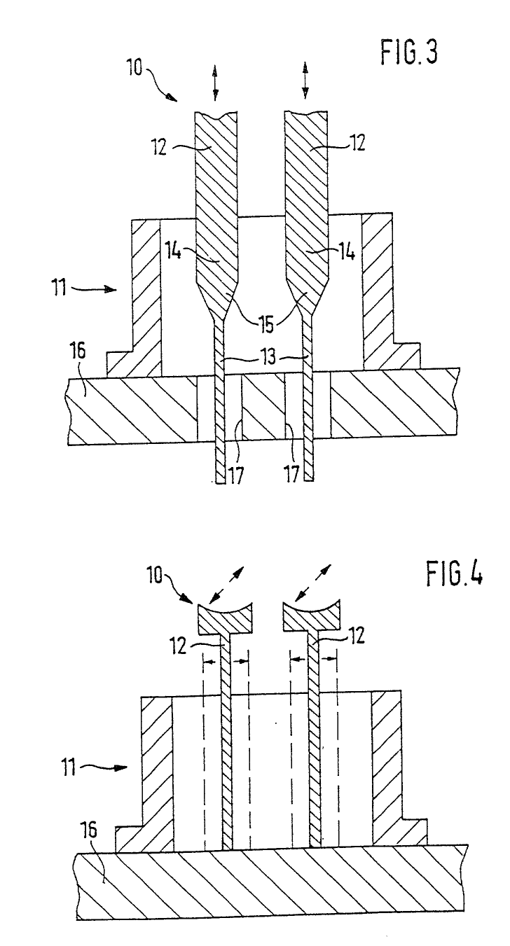

FIG. 3 shows a first preferred configuration of a device for manufacturing a catalyst carrier body according to the invention.

The device includes a mold 11 with a surrounding external flange, which is joined to a base plate 16 by non-illustrated fasteners, for example screws. Apertures 17 are formed in the base plate 16. Active winding spindles 12 of a twisting device 10 pass through the apertures 17. The active winding spindles 12 have first areas 13 and second areas 14. Respective cross-sectional surfaces of the apertures 17 approximately correspond to cross-sections of the respective second areas 14 of the active winding spindles 12. The height of the mold 11 corresponds substantially to an axial expanse of the first catalyst carrier body 2, which is twisted in the manufacturing device by relative rotation of the twisting device 10 against the mold 11 about a non-illustrated axis of symmetry of the manufacturing device, with the stacks or one such stack inserted in the mold 11. It does not matter whether the mold 11 or the twisting device 10 is actively moved.

The active winding spindles 12 can be moved individually or together, parallel to the axis of rotation of the manufacturing device. The direction of movement corresponds to the axial direction of the first catalyst carrier body 2. In particular, the axial movement takes place downwards, the first catalyst carrier body expands through the use of conical transition areas 15 of the respective active winding spindles 12 after the catalyst carrier body has been twisted and the first areas 13 of the respective active winding spindles 12 are engaged with the respective stack or stacks to be twisted. Optionally, a stop can be provided in the upper area on the mold 11 which prevents the catalyst carrier body from being pulled along after expansion because of tilting active winding spindles 12, when the active winding spindles 12 are withdrawn (upwards).

FIG. 4 shows a second preferred embodiment of the device for manufacturing a catalyst carrier body according to the invention.

The device of the second preferred configuration substantially corresponds to the device of FIG. 3. In this case, however, no apertures are necessary in the base plate 16, since the active winding spindles 12 apply substantially no axial force to the catalyst carrier body. In the case of the device of FIG. 4, the expansion of the twisted catalyst carrier body is accomplished by moving the active winding spindles 12 perpendicular to their respective longitudinal axis. Two planes of movement are indicated by arrows in FIG. 4. It is evident that the movement clearly takes place in all of the azimuthal angular directions. In particular, the movement can take place through the use of a rotating movement with an increasing radius which is provided by the respective active winding spindles 12 about their longitudinal axes. The maximum amplitude corresponds to the desired diameter of the cross-section of the through-flow aperture 5 to be produced in the catalyst carrier body. Such an amplitude is indicated by respective broken lines in FIG. 4 for both active winding spindles 12 which are shown.

The cross-section of the active winding spindles 12 is substantially circular for both the device according to FIG. 3 and the device according to FIG. 4. However, other cross-sections are possible in principle, in particular drop-shaped cross-sections.

We claim:

1. A catalytic converter configuration for exhaust gas systems of motor vehicles, the catalytic converter configuration comprising:
a housing;
at least first and second substantially successively disposed catalyst carrier bodies defining an exhaust gas flow profile, said catalyst carrier bodies each having axially extending channels with substantially pre-determined first cross-sectional areas;
said first catalyst carrier body having a central flow-receiving region, and said first catalyst carrier body having at least two through-flow apertures disposed decentrally to said exhaust gas flow profile, said through-flow apertures extending parallel to said axial channels and having second cross-sectional areas substantially larger than said first cross-sectional areas; and
at least some of said axial channels disposed between said through-flow apertures in said central flow-receiving region.

2. The catalytic converter configuration according to claim 1, wherein said second cross-sectional areas are 5 to 20 times larger than said first cross-sectional areas.

3. The catalytic converter configuration according to claim 1, wherein said second cross-sectional areas are 10 to 15 times larger than said first cross-sectional areas.

4. The catalytic converter configuration according to claim 1, wherein said first catalyst carrier body has a geometrical center point and a longitudinal axis extending through said geometrical center point, and said through-flow apertures have a geometrical center point of said second cross-sectional areas and longitudinal axes extending through said geometrical center point of said second cross-sectional areas, not coinciding with said longitudinal axis running though said geometrical center point of said first catalyst carrier body.

5. The catalytic converter configuration according to claim 1, wherein said first catalyst carrier body is installed close to an engine of the motor vehicle.

6. The catalytic converter configuration according to claim 1, wherein said first catalyst carrier body is disposed in an end region of a manifold of an internal combustion engine of the motor vehicle.

7. The catalytic converter configuration according to claim 1, wherein said catalyst carrier bodies are disposed in direct succession.

8. The catalytic converter configuration according to claim 1, wherein said catalyst carrier bodies are disposed in direct succession and spaced apart at a distance of 0.5 cm to 10 cm.

9. The catalytic converter configuration according to claim 1, wherein said catalyst carrier bodies are disposed in direct succession and spaced apart at a distance of 2 cm to 5 cm.

10. The catalytic converter configuration according to claim 1, wherein said housing is divided into several housing sections joined to one another by tubular connecting pieces, and said housing sections each receive a respective one of said catalyst carrier bodies.

11. The catalytic converter configuration according to claim 1, wherein said housing has one housing section receiving said catalyst carrier bodies.

12. The catalytic converter configuration according to claim 1, wherein at least said first catalyst carrier body is a honeycomb body formed substantially from sheet metal layers twisted in an S-shape and having said axial channels.

13. The catalytic converter configuration according to claim 1, wherein at least said first catalyst carrier body is a honeycomb body formed substantially from sheet metal layers twisted in an involute shape and having said axial channels.

14. The catalytic converter configuration according to claim 1, wherein at least said first catalyst carrier body is a honeycomb body formed substantially from twisted sheet metal layers, and said through-flow apertures each have a thickened edge.

15. The catalytic converter configuration according to claim 14, wherein said thickened edge is formed of a plurality of said sheet metal layers lying on top of one another.

16. A device for manufacturing a catalyst carrier body, comprising:
a mold having an inner contour corresponding to an outer contour of a catalyst carrier body to be manufactured; and
a fork-like twisting device substantially surrounded by said mold and rotatable about a central axis for engaging at least one stack of a multiplicity of at least partly structured sheet metal layers for forming the catalyst carrier body with a multiplicity of channels through which a fluid can flow;
said twisting device having active winding spindles to be brought into engagement with the at least one stack and moved for expanding the at least one stack after twisting.

17. The device according to claim 16, wherein said active winding spindles form through-flow apertures within the catalyst carrier body.

18. The device according to claim 17, wherein said active winding spindles have a first area with as small a cross-section as possible, a conical transition area and a second area with a larger cross-section, sequentially disposed in axial direction, said first area and said second area have an axial extent corresponding at least to an axial extent of the catalyst carrier body, and said second area has a cross-section substantially corresponding to a desired cross-section of said through-flow apertures.

19. The device according to claim 18, wherein said active winding spindles are movable in axial direction relative to the at least one stack.

20. The device according to claim 16, including a base plate for supporting the at least one stack against axial force applied by said active winding spindles, said base plate having apertures in the vicinity of said active winding spindles for entry of said active winding spindles.

21. The device according to claim 17, wherein said active winding spindles have a longitudinal axis and are movable perpendicular to said longitudinal axis, while maintaining an axial orientation relative to the at least one stack.

22. The device according to claim 21, wherein said active winding spindles are movable at an amplitude corresponding to a desired diameter of a cross-section of the through-flow apertures.

23. The device according to claim 16, wherein said mold and said twisting device are rotatable relative to one another.

24. A method for manufacturing a catalyst carrier body, which comprises:
layering at least one stack of a multiplicity of at least partly structured sheet metal layers;
inserting each stack into a mold substantially corresponding to an outer shape of the catalyst carrier body to be manufactured;
holding each stack with a twisting device disposed in a central area of the mold;
twisting all of the stacks into a catalyst carrier body entirely filling the mold, by exerting a relative rotation between the twisting device and the mold; and
moving active winding spindles of the twisting device to expand the twisted stacks.

25. The method according to claim 24, which further comprises introducing through-flow apertures into the catalyst carrier body while expanding the twisted stacks.

26. The method according to claim 24, which further comprises folding each stack about a respective bending line.

27. The method according to claim 24, which further comprises folding each stack about a respective bending line with an active winding spindle present in the vicinity of each respective bending line.

28. The method according to claim 24, which further comprises providing the mold as an open mold having at least two mold segments, enclosing the at least one stack in the open mold, and closing the mold by pivoting the mold segments counter to a direction of rotation of the twisting device, when a pre-determined degree of twisting is reached.
